(19) United States
(12) Patent Application Publication
(10) Pub. No.: US 2024/0145844 A1
(43) Pub. Date: May 2, 2024

(54) COMPRESSION PAD WITH A SELECTIVELY PERMEABLE OR SEMIPERMEABLE SEPARATING LAYER AND A METHOD FOR PRODUCING A BATTERY CELL STACK WITH THE COMPRESSION PAD

(71) Applicant: Dr. Ing. h.c. F. Porsche Aktiengesellschaft, Stuttgart (DE)

(72) Inventor: Dominik Grass, Bietigheim-Bissingen (DE)

(73) Assignee: Dr. Ing. h.c. F. Porsche Aktiengesellschaft, Stuttgart (DE)

(21) Appl. No.: 18/498,301

(22) Filed: Oct. 31, 2023

(30) Foreign Application Priority Data
Nov. 2, 2022 (DE) 10 2022 128 907.9

(51) Int. Cl. H01M 50/293; H01M 10/613; H01M 10/647; H01M 10/6551; H01M 10/6567; H01M 50/211

(52) U.S. Cl. CPC H01M 50/293; H01M 10/613; H01M 10/647; H01M 10/6551; H01M 10/6567; H01M 50/211; H01M 50/242

(57) ABSTRACT

A compression pad for a battery cell stack. The compression pad includes an interior space in which a filler material is provided. A surface of the compression pad surrounds the interior space. At least a portion of the surface of the compression pad includes a selectively permeable or semipermeable separating layer. Also described is a method for producing a battery cell module which includes the compression pad.

### CROSS-REFERENCE TO RELATED APPLICATION

This application claims priority to German Patent Application No. 10 2022 128 907.9, filed Nov. 2, 2022, the content of such application being incorporated by reference herein in its entirety.

### FIELD OF THE INVENTION

The present invention relates to a compression pad for a battery cell stack (battery cell packet). The invention also relates to a method for producing for a battery cell stack which has compression pads with a selectively permeable or semipermeable separating layer.

### BACKGROUND OF THE INVENTION

The range of electric vehicles is largely determined by the traction battery installed in them. Nowadays, appropriately sized high-voltage batteries made up of battery cell modules (also referred to as battery modules), each of which in turn contains a number of battery cells that each represent the smallest self-contained energy storage cell, are used to power modern electric vehicles. The two-deck Performance Battery Plus, for instance, which is used in some models of the Porsche Taycan, comprises 33 cell modules that each consist of twelve individual battery cells. The traction battery thus comprises a total of 396 battery cells, wherein lithium-ion batteries are used as the battery cells. The traction battery has a system voltage of 800 volts and a total capacity of 93.4 kWh.

The batteries are basically built using battery modules in which multiple cells are arranged in parallel, wherein a compression pad (also referred to as a compression insert) is arranged between each two cells. The compression pads arranged between the battery cells perform another important task, namely providing compensation for the increasing cell thicknesses (swelling). Swelling is a change in the volume of a battery cell in particular a lithium ion cell, which can be observed, on the one hand, during charging and discharging and, on the other hand, is caused on a slower time scale by aging of the battery cell. Swelling is caused by a structural change in the active layers inside the battery cell, which results from the rearrangement of lithium ions that occurs in said cells. Swelling is particularly pronounced in pouch cells, which is a widely used design of battery cells. Placing compression pads between the battery cells in their stacking direction as mentioned above, enables said pads to equalize the volume change of the battery cells within a battery module by compressing.

The compressible pads can also be used to build up forces in the battery cell packet by means of which said battery cell packet can be clamped in the housing (battery housing or module housing). In order to achieve a good pretensioning, the external dimensions of the battery cell packet usually differ only slightly from the internal dimensions of the housing. Pure foam pads, which are highly compressible, are currently used as compression pads. The battery cell packet is therefore overcompressed during installation to temporarily reduce its dimensions, and is pushed into the housing in this overcompressed state, which complicates the process of inserting the battery cell stack and consequently makes it relatively complex in terms of the process. The insertion process then takes place using specific insertion forces, because the battery cell packet presses from the inside against the inner sides of the housing when it is inserted, which results in frictional forces by which either the battery cells or the compression pads can be damaged.

US 2014/141307 A1, which is incorporated by reference herein, describes a typical production process for a battery with a battery housing and multiple battery cells which are arranged adjacent to one another in said housing, wherein a foam compression pad, which is compressed during the assembly process and expands after assembly, is arranged between each two adjacent battery cells.

Within the context of a battery, GB 1197468 A, which is incorporated by reference herein, discloses the use of separators for separating electrodes that expand when wetted.

WO 2021/233778 A1, which is incorporated by reference herein, discloses a battery with multiple adjacently arranged battery cells, wherein a heat sink which, due to an elastic outer skin, also serves as a compression pad, is arranged between each two adjacent battery cells.

### SUMMARY OF THE INVENTION

Based on the compression pads known from the prior art, described herein are compression pads and a corresponding production method that facilitate the process of inserting the battery cell packet in the housing.

According to aspects of the invention, a compression pad for a battery cell stack is provided in a variety of embodiments and comprises an interior space, in which a filler material is provided, and a surface surrounding the interior space, wherein at least a portion of the surface of the compression pad comprises a selectively permeable or semipermeable separating layer, which can comprise a selectively permeable or semipermeable membrane, for example. For the sake of brevity, only a semipermeable separating layer will be discussed in the following, which can, however, always also comprise a selectively permeable separating layer.

The compression pads have a smaller volume in the assembly state than in the later operating state, without the need to actively apply pressure to them. In other words, the assembly state can be understood to be the inactivated state of the compression pads, whereas, in the operating state, the compression pads according to aspects of the invention are in an activated state. With the compression pads in the assembly state, a cell stack can be constructed that is undersized with respect to its installation space in the housing and can therefore easily be inserted into a battery module or battery housing.

According to aspects of the invention, osmosis is used to transfer the compression pads according to aspects of the invention from the assembly state to the operating state. For this purpose, the compression pad according to aspects of the invention has a surface which, at least in a section, comprises a semipermeable separating layer, such as a corresponding membrane. The compression pad according to aspects of the invention can also be completely covered with the semipermeable separating layer. In view of its mode of functioning, the compression pad according to aspects of the invention can also be referred to as an osmotic compression pad.

The compression pad according to aspects of the invention can be incorporated in the cell stack, which is installed in a suitable housing. The activation or transfer of the compression pads according to aspects of the invention into the operating state takes place in the housing by bringing the semipermeable separating layer into contact with a solvent. The semipermeable separating layer can be permeable to said solvent, so that the solvent can flow through said separating layer into the interior of the compression pads according to aspects of the invention in order to equalize the concentration difference or the difference between the chemical potentials of one or more substances in the phases separated by the membrane and their different concentrations inside and outside the semipermeable separating layer. As a result, the compression pad according to aspects of the invention increases in volume and thereby builds up the necessary pressure on the battery cells to clamp them inside the housing.

The interior space of the compression pad according to aspects of the invention can accommodate the inflowing fluid volume, for which purpose it can comprise distributed cavities, for instance. The initial flow of the solvent into the interior space of the compression pad can be driven by capillary forces in addition to the chemical potentials or the concentration differences of the separated phases when the membrane is wetted with the solvent. Once the solvent has flowed into the interior space, osmotic pressure builds up, which allows more solvent to flow from the outside through the semipermeable separating layer into the interior space of the compression pad. A substance can additionally be provided in the interior space of the compression pads according to aspects of the invention, which is dissolved by the initially inflowing solvent and creates a concentration gradient that further intensifies the inflow of the solvent. In that case, the membrane can be impermeable to this substance. In the context of this description, a solvent can be a fluid which is a part of at least one of the phases separated by the membrane and which can pass through the membrane to reduce a concentration difference or a difference in chemical potentials between the two phases.

The portion of the surface of the compression pad which comprises a semipermeable separating layer can in particular be regions of the compression pad that do not rest against the battery cells inside the battery cell stack constructed with it; such as, when looking at the battery cell stack in a lateral cross-section, the upper side and underside of a, for instance, cuboidal or cushion-shaped compression pad.

The osmosis process and thus the pressure build-up of the compression pad can furthermore also be brought about by a gas from the surroundings during assembly before a fluid is then introduced into the battery in a later filling process.

According to further embodiments of the compression pad according to aspects of the invention, the filler material can comprise a substance which is elastic after the osmosis process, for example a plastic, in particular a porous plastic, such as a foamed polymer. The filler material can alternatively comprise an elastomer, which can have perforations into which the solvent can flow. Before the osmosis process takes place, the filler material does not have to be elastic but can be solid, or it can be elastic but have a greater material hardness.

According to further embodiments of the compression pad according to aspects of the invention, the filler material can exhibit a difference between chemical potentials and a concentration difference between the phases separated by the selectively permeable or semipermeable separating layer.

According to aspects of the invention, a method for producing a battery cell module is provided as well, wherein said method can also be used to produce the higher-level entity of said battery cell module, namely a battery. In a first step, the method includes preparation of a battery cell packet, which has an arrangement of battery cells, wherein an osmotic compression pad according to one of the previously described embodiments is arranged between each two battery cells. The battery cells can be in the form of pouch cells, for example. As the next step, the method includes inserting the battery cell packet into a housing, wherein the battery cell packet is undersized relative to the installation space provided for it in the housing. The method then includes introducing a fluid or a gas into the housing so that it comes into contact with the semipermeable separating layer of the compression pads and flows through it into the compression pads to equalize the concentration difference. The fluid can be the aforementioned solvent.

According to further embodiments of the production method according to aspects of the invention, the fluid can be a cooling medium. The battery cell module or the corresponding battery can be a directly cooled battery cell module or a directly cooled battery. These are characterized by a cooling system in which the cooling medium flows directly around the battery cells. The cooling medium also flows directly around the compression pads. Therefore, in such an embodiment, a fluid is used which is also used as the cooling medium in the battery module or battery.

According to further embodiments the compression pads and/or the fluid can contain a substance, the concentration of which is lower in the compression pads than in the fluid. In this case, the semipermeable separating layer can at the same time be impermeable to this substance. This allows a concentration gradient to be established, which further drives the flow of the fluid into the compression pads according to aspects of the invention.

According to aspects of the invention, the use of osmosis to cause an expansion of a compression pad, which is arranged in a battery cell stack inside a housing and/or while a fluid or a gas is flowing around it, is presented as well.

It goes without saying that the aforementioned features and the features yet to be explained in the following can be used not only in the respectively specified combination, but also in other combinations or on their own, without leaving the scope of the present invention.

### BRIEF DESCRIPTION OF THE DRAWINGS

Further advantages and configurations of the invention will emerge from the description and the accompanying drawings.

FIG. 1 illustrates the installation of a battery cell stack with compression pads according to aspects of the invention in the assembly state into a housing.

FIG. 2 illustrates a housing with an installed battery cell stack with compression pads in the operating state.

### DETAILED DESCRIPTION OF THE INVENTION

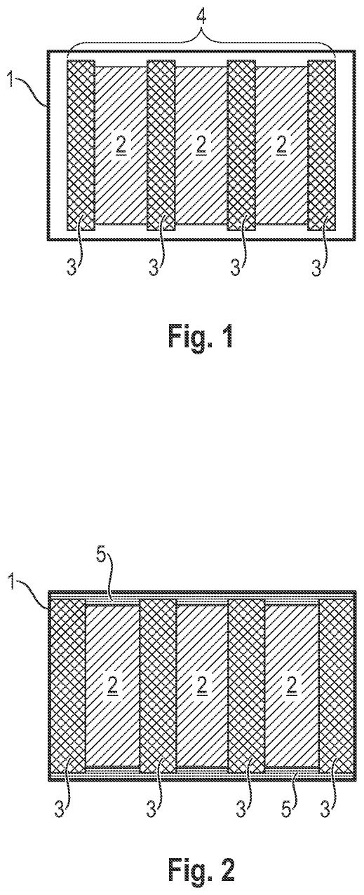

FIG. 1 is a sketch of a battery cell stack 4 shortly after it has been inserted into a housing 1. In the shown example, the battery cell stack 4 comprises three battery cells 2, which are respectively separated from one another by a compression pad 3 according to aspects of the invention. One such a compression pad 3 is also provided at each end of the cell stack 4. Since the compression pads 3 are in the assembly state, i.e. in the unexpanded state, the battery cell stack 4 is undersized and can be inserted into the housing 1 relatively easily without any special measures.

FIG. 2 shows the battery cell stack 4 in operation of the associated battery module or the associated battery. Here, the compression pads 3 have been activated by passing a fluid 5 through the liquid cooling system flow paths provided in the housing 1. The flow paths can be formed between the inner walls of the housing 1 and the surfaces of the battery cells 2 and the compression pads 3, so that a directly cooled battery cell packet 4 is provided. As the fluid 5 flows through the housing 1, it comes into contact with and flows through the semipermeable separating layer of the compression pads 3 to equalize the concentration difference inside and outside the semipermeable separating layer. The compression pad 3 consequently increases in volume and thereby builds up the necessary pressure on the battery cells 2 to clamp them inside the housing 1. As FIG. 2 illustrates, there is no longer any axial free space between the battery cell stack 4 with activated compression pads 3 and the inner wall of the housing 1.

As mentioned above, the compression pads can be activated by separately passing a fluid through the cooling system of the battery or the battery module. The liquid cooling medium can alternatively function as a fluid, so that there is no need for a separate activation step.

For this purpose, the cooling medium can comprise further additives to enhance osmosis through the semipermeable separating layer.

What is claimed is:

1. A compression pad for a battery cell stack, said compression pad comprising:
a surface surrounding an interior space, wherein at least a portion of the surface of comprises a selectively permeable or semipermeable separating layer; and
a filler material disposed in the interior space.

2. The compression pad according to claim 1, wherein the filler material comprises a substance which is elastic after an osmosis process.

3. The compression pad according to claim 1, wherein the filler material exhibits a difference between chemical potentials and a concentration difference between phases separated by the selectively permeable or semipermeable membrane.

4. A battery cell module comprising a housing and a battery cell stack positioned within the housing, wherein the battery cell stack includes at least one of the compression claim 1.

5. A method for producing a battery cell module including (a) a housing and (b) a battery cell stack disposed in the housing, the battery cell stack including a plurality of battery cells and a compression pad, the compression pad including (i) a surface having a selectively permeable or semipermeable separating layer surrounding an interior space of the compression pad, and (ii) a filler material disposed in the interior space, said method comprising:
arranging the compression pad between two battery cells of the plurality of battery cells to form the battery cell stack,
inserting the battery cell stack into the housing, wherein the battery cell stack is undersized relative to an installation space provided in the housing for the battery cell stack; and
introducing a fluid or a gas into the housing so that the fluid or gas comes into contact with the separating layer of the compression pad and flows through the separating layer into the compression pad in order to equalize a concentration difference.

6. The method according to claim 5, wherein the fluid is a cooling medium.

7. The method according to claim 5, wherein the compression pad and/or the fluid contains a substance, the concentration of which is lower in the compression pad than in the fluid.

8. Use of osmosis to cause an expansion of a compression pad which is arranged in a battery cell stack inside a housing and around which a fluid or gas flows.
